(19) United States
(12) Patent Application Publication
(10) Pub. No.: US 2020/0222796 A1
(43) Pub. Date: Jul. 16, 2020

(54) Three-dimensional Puzzle Set

(71) Applicant: Meir Sela, Nitzanei Oz (IL)

(72) Inventor: Meir Sela, Nitzanei Oz (IL)

(21) Appl. No.: 16/707,690

(22) Filed: Dec. 9, 2019

Related U.S. Application Data
(60) Provisional application No. 62/777,257, filed on Dec. 10, 2018.

(51) Int. Cl. A63F 9/06; A63F 9/12

(52) U.S. Cl. CPC A63F 9/0612; G09B 23/185; A63F 9/1208

(57) ABSTRACT

System and method for a three-dimensional puzzle set, with puzzle pieces optionally comprising electrical circuits and electrical components such that when two or more puzzle pieces are assembled an electrical circuit is formed along the puzzle assembly, activating the electrical components. The puzzle pieces have spherical projections and spherical recesses, where the spherical projections mate with the spherical recesses and can be inserted in various angles, enabling the forming of three-dimensional structures.

The present invention extends puzzles from two dimensions to three dimensions, and optionally integrates these three-dimensional puzzles with electrical circuits. The puzzle “language” of connecting pieces to each other is used as the electrical language to build electrical circuits. Specifically, electrical principles such as electric current flow and input-output are well visualized by puzzle assembly projections and recesses.

These, additional, and/or other aspects and/or advantages of the present invention are set forth in the detailed description which follows; possibly inferable from the detailed description; and/or learnable by practice of the present invention.

### CROSS-REFERENCE TO RELATED APPLICATIONS

This application claims benefit of provisional application No. 62/777,257 filed on 10 Dec. 2018.

### BACKGROUND OF THE INVENTION

Puzzles are well known as amusement games. The game participants are expected to solve a given problem by putting pieces together in a logical way, in order to arrive correct or fun solutions. More specifically, jigsaw puzzles are common board games, in which game users construct two-dimensional images by assembling puzzle pieces together.

Existing puzzles are mostly two-dimensional. Existing mechanisms for making puzzle sets three-dimensional are based on either (1) adding of special corner pieces, (2) making the puzzle pieces rounded so that they can be laid along curved structures, (3) make successive and parallel layers of two-dimensional puzzles to generate the third dimension, and (4) using magnets to be able connect puzzle pieces both horizontally and vertically. Yet no three-dimensional puzzle sets exist where the puzzle pieces interlocking mechanism inherently supports the rotation of the interlocked puzzles relative to each other and further enables puzzle pieces to be assembled in various angles.

Electronics learning kits are used to teach users electricity and electronics by constructing electrical circuits. As defined by Wikipedia, “An electronic kit is a package of electrical components used to build an electronic device. Generally, kits are composed of electronic components, a circuit diagram (schematic), assembly instructions and often a printed circuit board (PCB) or another type of prototyping board”. Integrating of electronics kits with mechanic building blocks is popular in science and technology education as it can demonstrate advanced mechanics and electronics principles. Thus, using a popular building blocks mechanic such as puzzles, integrated with electronic circuits, would have great educational benefits.

Robot learning kits are electronic learning kits with the addition of mechanic elements and programming. Robot kits let users build three-dimensional structures using mechanical parts, wherein some of the parts can be moved or rotated using electrical motors. Sensors are used to get information about the environment and to interact with it. Said robot structures can then be programmed by either writing a computer code to a microcontroller which is part of the robot electronic circuit. Further methods for programming robot structure comprise sense-act programming model (AKA Braitenberg Vehicle) and analog circuit comparators (AKA BEAM robotics).

A side and B side hereinafter refer to the two puzzle piece opposite surfaces, top and bottom respectively, as depicted in FIGS. 14 and 15. These and other terms used to depict direction and orientation are only used to aid reader's understanding of the present invention, and do not create limitation on the use of the invention.

Parallel mating or parallel assembly hereinafter is mating two puzzle pieces where their top (or bottom) surfaces are parallel, as depicted in FIG. 12 in 12e. Perpendicular mating or perpendicular assembly hereinafter is mating two puzzle pieces wherein their top (or bottom) surfaces are perpendicular.

Mating point of two puzzle pieces hereinafter is the center point of the ellipsoid joint as depicted in FIG. 5, wherein 5a depicts one embodiment of parallel mating and wherein 5b, 5c and 5d depict one embodiment of perpendicular mating, wherein within each of said embodiments said mating point is the center of the mated spherical projection and the spherical recess.

Pitch-rotation hereinafter is a vertical rotation of one puzzle piece with relation to the mating point in a two-piece puzzle assembly as depicted in FIGS. 12 and 13. It is implemented by either rotating said mated puzzle piece up or down with relation to the other mated puzzle piece top and bottom surfaces respectively.

Roll-rotation hereinafter is a rotation of one puzzle piece with relation to the mating point in a two-piece puzzle assembly as depicted in FIGS. 8 and 9. It is implemented by either rotating said mated puzzle piece clockwise or counterclockwise around an axis perpendicular to the other mated puzzle piece's top (or bottom) surfaces.

Mating angle hereinafter is the angle generated by either pitch-rotation or roll-rotation between two mated puzzle pieces. In a pitch-rotation said mating angle is the angle between top surfaces of two mated puzzle pieces with relation to the mating point, as depicted in FIGS. 12 and 13. In a roll-rotation said mating angle is the angle of a mated puzzle piece with relation to its rotation axis, as depicted in FIG. 8 where the axis is depicted in 8a, and as depicted in FIG. 9 where the rotation axis is depicted in 9c.

Mechanical interlock hereinafter is an interlocking of two puzzle pieces implemented by inserting one puzzle piece's ellipsoid projection into the other puzzle piece's recess, as depicted in FIGS. 5, 6 and 7, thus preventing the two puzzle pieces from falling apart.

Rounded surface edges (AKA fillets) hereinafter of the puzzle pieces as depicted in FIG. 23 in 23c are generated by rounding the 90 degrees edge profile which is the outcome of joining of two perpendicular surfaces. Rounded edges make it easier for the user to insert a projection into a recess. Furthermore, rounded edges ease rotation of puzzle pieces and increase the range of the rotation.

The above terms and other terms used in this specification are only used to aid reader's understanding of the present invention, and do not create limitation on the use of the invention.

The present invention belongs to the field of puzzle amusement games and educative games. The present invention enables playing puzzle games in a three-dimensional space, optionally building electrical circuits and robots, thus enhancing three-dimensional orientation and perception, along with learning of science and technology.

### BRIEF SUMMARY OF THE INVENTION

The present invention is a system and method for a three-dimensional puzzle, said puzzle optionally comprising electrical circuits and components. The present invention is based on a principle of a spherical projection of one puzzle piece inserted into a spherical recess of another puzzle piece, and the friction formed due to the significant surface touching area is enough to hold the angled puzzle piece from falling. At the heart of this principle is a spherical interlock, which is formed when a projection is inserted into a recess, where the spherical shape of the recess accommodating section matches the spherical shape of the projection, thus causing an interlock after insertion. It will be appreciated to those skilled in the art that using flexible materials for the puzzle pieces is one of several methods enabling said projection to be snapped into said recess.

According to the present invention electrical circuits can be formed by assembling puzzle pieces. In one embodiment of the present invention electrical contacts are placed on several sides of a puzzle piece to allow multi directional assembly of puzzle pieces. In one embodiment of the present invention male spring contacts are placed on the puzzle piece side surfaces, and when said puzzle piece is assembled with a second puzzle piece said spring contacts are pressed onto said second puzzle piece's matching female contacts. The projection-recess interlock presses the two puzzle pieces towards each other, thus pressing the spring contact towards the matching female contact.

In a non-limiting example of the present invention, an assembly of three puzzle pieces each comprising electrical three-position male and female contacts and extra electrical components: a proximity sensor puzzle piece, a speaker puzzle piece and a USB connector puzzle piece. In this embodiment when the proximity sensor senses an object it outputs a corresponding value on the signal contact, which moves into the speaker puzzle piece and causes the speaker to make a sound. The power to the whole assembly is coming in this embodiment from the USB puzzle piece, when connected with a suitable cable to a wall adapter or to a computer USB output.

The previous was just non-limiting example of a basic puzzle circuit containing one sensor, one actuator and one power source. In alternative embodiments, a puzzle piece assembly may contain a plurality of sensor puzzle pieces of various types, a plurality of actuator puzzle pieces of various types and power source puzzle pieces of various types. Non-limiting examples of other sensor types are temperature sensor, pressure sensor, microphone, touch sensor, push button, switch button, slider switch, etc. Non-limiting examples of other actuator types are LED, electrical motor, LCD screen, etc.

### BRIEF DESCRIPTION OF THE DRAWINGS

In order to understand the invention and to see how it may be implemented in practice, a plurality of embodiments will now be described, by way of non-limiting example only, with reference to the accompanying drawings, in which:

FIG. 1 depicts an example of a two-dimensional jigsaw puzzle forming a picture.

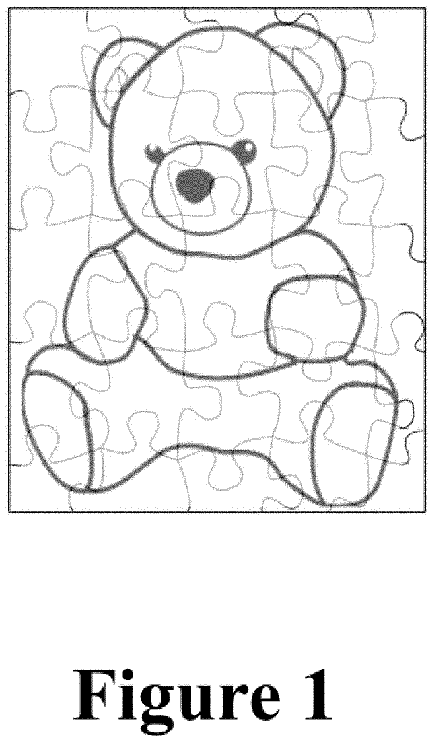

FIG. 2 depicts non-limiting puzzle assembly samples of the present invention, where stairs (2b) and chair (2a) are three-dimensional assemblies of puzzle pieces.

FIG. 3 depicts one possible embodiment of the structure of the basic puzzle piece of the present invention. The puzzle piece two projections and two recesses are spherical, enabling assembly of two pieces either horizontally (180 degrees) or vertically (90 degree). 3a depicts the recesses of said puzzle piece. 3b depicts the projections of said puzzle piece. 3c depicts the side surface of said puzzle piece. 3d depicts the flat top part of said puzzle piece.

FIG. 4 depicts puzzle piece spherical projections and spherical recesses used in projection-recess interlocks. 4a depicts said puzzle piece spherical projection. 4b depicts said puzzle piece spherical recess. 4c depicts said puzzle piece with projection edges rounded, used to facilitate the insertion of projections into recesses and the rotations around each other.

FIG. 5 depicts another possible embodiment of the present invention, where puzzle pieces are assembled in various vertical forms. 5a depicts a horizontal assembly of two puzzle pieces where the projection is inserted top-down into a horizontal recess. 5b depicts a vertical assembly of two puzzle pieces where the projection is inserted horizontally into another vertical puzzle piece's recess. 5c depicts a vertical assembly of two puzzle pieces where the projection is inserted vertically bottom-up into another horizontal puzzle piece's recess. 5d depicts a vertical assembly of two puzzle pieces where the projection is inserted vertically top-down into another horizontal puzzle piece's recess. 5e depicts a vertical assembly of two puzzle pieces where the side surface (depicted in 3c) of the vertical piece attaching the top part of the horizontal piece, contributing to the stability of the assembly.

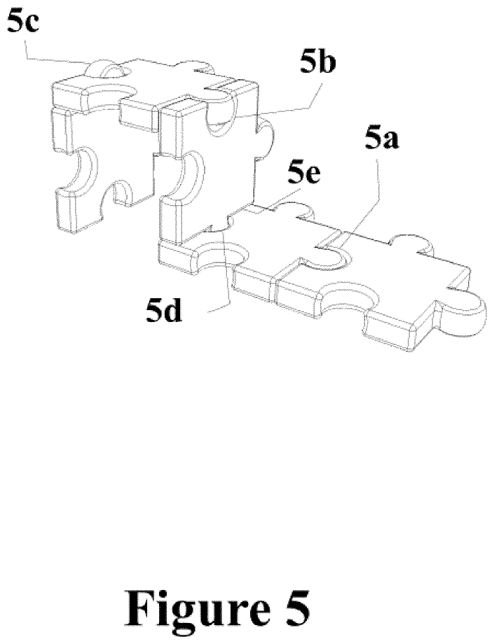

FIG. 6 depicts a perspective view of two puzzle pieces just before assembled vertically. 6a depicts the left spherical surface area of the projection of the top puzzle piece which is about to attach the left spherical surface area of the recess of the bottom puzzle piece. 6b depicts the left spherical surface area of the recess of the bottom puzzle piece which is about to attach the left spherical surface area of the projection of the top puzzle piece. 6c depicts the right spherical surface area of the projection of the top puzzle piece which is about to attach the right spherical surface area of the recess of the bottom puzzle piece. 6d depicts the right spherical surface area of the recess of the bottom puzzle piece which is about to attach the right spherical surface area of the projection of the top puzzle piece.

FIG. 7 depicts a side view of two puzzle pieces just before assembled vertically. 7a depicts the left spherical shape of the projection of the top puzzle piece which is about to be inserted into the left spherical shape of the recess of the bottom puzzle piece. 7b depicts the left spherical shape of the recess of the bottom puzzle piece which is about to attach the left spherical shape of the projection of the top puzzle piece. 7c depicts the right spherical shape of the projection of the top puzzle piece which is about to attach the right spherical shape of the recess of the bottom puzzle piece. 7d depicts the right spherical shape of the recess of the bottom puzzle piece which is about to attach the right spherical shape of the projection of the top puzzle piece.

FIG. 8 depicts a perspective front view of two puzzle pieces assembled vertically where the top puzzle piece is rotated around the vertical axis. 8a depicts a vertical axis of which the top puzzle piece's projection rotates around inside the bottom puzzle piece's recess.

FIG. 9 depicts a perspective back view of two puzzle pieces assembled vertically where the top puzzle piece is rotated around the vertical axis. 9a depicts the bottom puzzle piece's recess left edge. 9b depicts the bottom puzzle piece's recess right edge. 9c depicts a vertical axis of which the top puzzle piece's projection rotates around inside the bottom puzzle piece's recess.

FIG. 10 depicts another possible diagrammatic representation of an embodiment of the present invention, where the puzzle pieces are assembled in various angles, not limited to horizontal (180 degrees) and vertical (90 degrees) angles, forming a TV chair. 10a depicts a front view of the TV chair. 10b depicts a side view of the TV chair. 10c depicts an assembly of two pieces with an obtuse angle between the backrest and the seat. 10d depicts an assembly of two pieces with an obtuse angle between the footrest and the seat. 10e depicts a side view of an assembly of two pieces with an obtuse angle between the backrest and the seat. 10f depicts a side view of an assembly of two pieces with an obtuse angle between the footrest and the seat.

FIG. 11 depicts an assembly of two puzzle pieces with an obtuse angle between them. 11a depicts a front view of an assembly of two puzzle pieces with an obtuse angle between them. 11b depicts a back view of an assembly of two puzzle pieces with an obtuse angle between them. 11c depicts a front view of a projection obtuse angle relative to the matching recess. 11d depicts a back view of a projection obtuse angle relative to the matching recess. 11e depicts an attachment of a on puzzle piece side surface to another puzzle piece top surface. 11f depicts a rounding of a projection edge which enables rotating around a recess. 11g depicts a rounding of a side surface top edge which enables rotating around another puzzle piece side surface. 11h depicts a rounding of a side surface bottom edge which enables rotating around another puzzle piece side surface. 11i depicts a rounding of a recess edge which enables rotating around a projection. 11j depicts a rounding of a side surface top edge on the non-rotating puzzle piece.

FIG. 12 depicts incremental rotating of one puzzle piece around another, where the projection of the rotating puzzle piece rotates inside the recess of the non-rotating puzzle piece starting in a right-angle (90 degrees) and ending in a straight angle (180 degrees). 12a depicts a 90 degrees angle between a projection of the rotating puzzle piece and the recess of a non-rotating puzzle piece. 12b depicts a 110 degrees angle between a projection of the rotating puzzle piece and the recess of a non-rotating puzzle piece. 12c depicts a 130 degrees angle between a projection of the rotating puzzle piece and the recess of a non-rotating puzzle piece. 12d depicts a 150 degrees angle between a projection of the rotating puzzle piece and the recess of a non-rotating puzzle piece. 12e depicts a 180 degrees angle between a projection of the rotating puzzle piece and the recess of a non-rotating puzzle piece.

FIG. 13 depicts incremental rotating of one puzzle piece around another, where the projection of the rotating puzzle piece rotates inside the recess of the non-rotating puzzle piece starting in a straight angle (180 degrees) and ending in a right-angle (90 degrees). 13a depicts a 180 degrees angle between a projection of the rotating puzzle piece and the recess of a non-rotating puzzle piece. 13b depicts a 200 degrees angle between a projection of the rotating puzzle piece and the recess of a non-rotating puzzle piece. 13c depicts a 220 degrees angle between a projection of the rotating puzzle piece and the recess of a non-rotating puzzle piece. 13d depicts a 240 degrees angle between a projection of the rotating puzzle piece and the recess of a non-rotating puzzle piece. 13e depicts a 270 degrees angle between a projection of the rotating puzzle piece and the recess of a non-rotating puzzle piece.

FIG. 14 depicts a perspective view of a puzzle piece comprising electrical female contacts. 14a to 14d depict electrical contacts (female contact) in a puzzle piece stretching from said puzzle piece's top part (A side) along its side surface down to bottom side (B side).

FIG. 15 depicts a perspective view of a puzzle piece comprising electrical female contacts and electrical spring male contacts. 15a to 15d depict continuations of the electrical female contacts on said puzzle piece depicted in 14a to 14d, respectively. 15e and 15f depict electrical spring male contacts on said puzzle piece.

FIG. 16 depicts a perspective view of a straight angle assembly of two puzzle pieces each comprising electrical female contacts and electrical spring male contacts. 16a depicts a projection interlocked into the recess in a straight angle assembly of two puzzle pieces. 16b depicts an electrical spring male contact (hidden between the two side surfaces) attaching another puzzle piece's electrical female contact in a straight angle assembly of two puzzle pieces.

FIG. 17 depicts a perspective view of a right-angle assembly of two puzzle pieces each comprising electrical female contacts and electrical spring male contacts. 17a depicts a perspective view of a right-angle assembly of two puzzle pieces each comprising electrical female contacts and electrical spring male contacts just before fully inserting top puzzle piece's projection into bottom puzzle piece's recess. 17b depicts a perspective view of a right-angle assembly of two puzzle pieces each comprising electrical female contacts and electrical spring male contacts right after fully inserting top puzzle piece's projection into bottom puzzle piece's recess.

FIG. 18 depicts a perspective view of a right-angle assembly of two puzzle pieces comprising electrical contacts with top puzzle piece rotated 180 degrees around its vertical axis depicted in 18c. 18a depicts a perspective view of a right-angle assembly of two puzzle pieces comprising electrical contacts with top puzzle piece rotated 180 degrees around its vertical axis depicted in 18c. 18b depicts a perspective view of a right-angle assembly of two puzzle pieces comprising electrical contacts with top puzzle piece rotated 180 degrees around its vertical axis depicted in 18c and bottom puzzle piece rotated 180 degrees around its horizontal axis depicted in 18d.

FIG. 19 depicts a perspective view of a puzzle piece comprising three-position electrical female contacts and three-position electrical spring male contacts. 19a depicts a perspective view of side A of a puzzle piece comprising three-position electrical female contacts and three-position electrical spring male contacts. 19b depicts a perspective view of side B of a puzzle piece comprising three-position electrical female contacts and three-position electrical spring male contacts. 19c depicts a perspective view of a puzzle piece comprising three-position electrical female contacts and three-position electrical spring male contacts with markings of each of the contacts: power/plus (+), ground/minus (−) and signal(s).

FIG. 20 depicts a perspective view of an assembly of two puzzle pieces each comprising three-position electrical female contacts and three-position electrical spring male contacts. 20a depicts a perspective view of a straight angle assembly of two puzzle pieces each comprising three-position electrical female contacts and three-position electrical spring male contacts. 20b depicts a perspective view of a right-angle assembly of two puzzle pieces each comprising three-position electrical female contacts and three-position electrical spring male contacts.

FIG. 21 depicts a perspective view of an obtuse angle assembly of two puzzle pieces each comprising three-position electrical female contacts and three-position electrical spring male contacts. 21a depicts a perspective view of an obtuse angle assembly of two puzzle pieces each comprising three-position electrical female contacts and three-position electrical spring male contacts. 21b depicts a perspective side view of an obtuse angle assembly of two puzzle pieces each comprising three-position electrical female contacts and three-position electrical spring male contacts.

FIG. 22 depicts a perspective view of an assembly of three puzzle pieces each comprising three-position electrical male and female contacts and electrical components. 22a depicts a perspective front view of an assembly of three puzzle pieces each comprising electrical male and female contacts and extra electrical components. 22b depicts a perspective back view of an assembly of three puzzle pieces each comprising electrical male and female contacts and extra electrical components, where the proximity puzzle piece is rotated around its vertical axis in 180 degrees so that it turns to opposite direction from that depicted in 22a. 22c depicts a puzzle piece comprising electrical male and female contacts and a proximity sensor. 22d depicts a puzzle piece comprising electrical male and female contacts and a speaker (AKA buzzer). 22e depicts a puzzle piece comprising electrical male and female contacts and a USB connector.

FIG. 23 depicts the electrical circuit of the puzzle assembly depicted in FIG. 22. 23a depicts the proximity sensor inside the proximity sensor puzzle piece. 23b depicts the signal going from the proximity sensor into the speaker. 23c depicts the power/plus (+) and ground/minus (−) connected through all three puzzle pieces.

FIG. 24 depicts mated puzzle pieces with ellipsoid projections and recesses. 24a is a single puzzle piece with ellipsoid projections and recesses. 24b depicts horizontal mating of two puzzle pieces with ellipsoid projections and recesses. 24c depicts perpendicular mating of two puzzle pieces with ellipsoid projections and recesses.

FIG. 25 depicts a close look at a spherical recess: 25a is a view of the spherical curvature, 25b shows said recess opening in the top surface, and 25a and 25d show said recess opening in the side surface.

FIG. 26 depicts two mating of puzzle pieces with male and female connectors as in FIG. 82: 26a depicts perpendicular mating of two puzzle pieces. 26b depicts roll-rotation of two mating puzzle pieces, where the conductive contact is retained while rolling due to the male connector continuously contacting the female conduit.

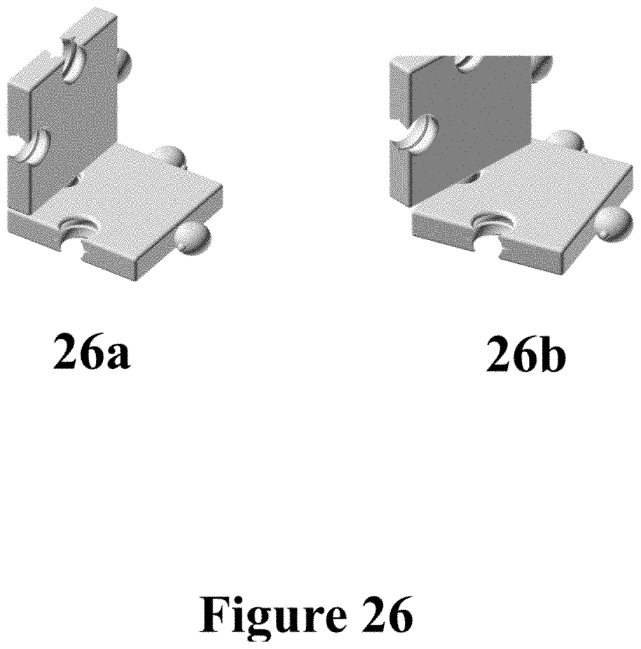

FIG. 27 depicts a puzzle piece comprising 27a three-position spherical male connector located on said puzzle piece's projection and 27b matching three-positions female conductive conduit within said puzzle piece's recesses.

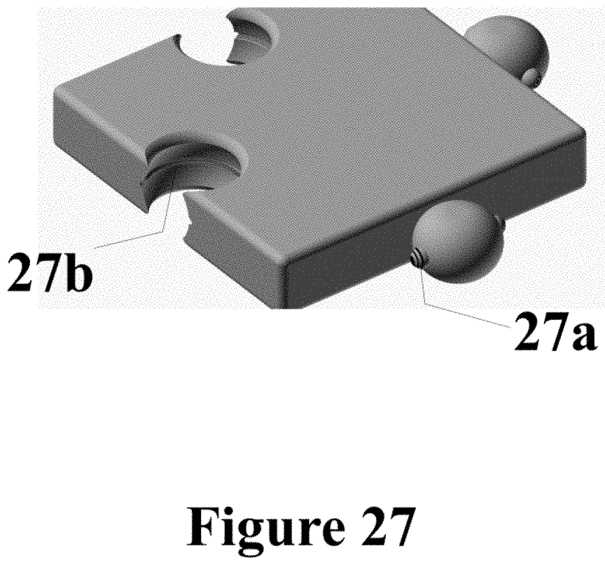

FIG. 28 depicts two mated puzzle pieces with arc-shape three-position conductive contacts on their top and bottom surfaces. The top puzzle piece is roll-rotating while keeping conduction between its 28d (also depicted in 28b) spring three-position contact and the other puzzle piece's 28c (also depicted in 28a) arc-shape three-position conductive contact.

FIG. 29 depicts puzzle pieces with arc-shape one-position conductive contacts. 29a depicts arc-shape one-position conductive contacts on a puzzle piece's top surface. 29b depicts one-position spring contacts on said puzzle piece's side surface. 29c and 29d respectively depict said arc-shape contacts and spring contacts in a roll-rotation of two puzzle pieces.

FIG. 30 depicts an insertion of one puzzle piece's projection into another puzzle piece's recess, by first rotating it 90 degrees (30a), then inserting it (30b) and finally rotating it back 90 degrees (30c).

### DETAILED DESCRIPTION OF THE INVENTION

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide a means and method for providing a system and method for a three-dimensional puzzle.

In the following detailed description, numerous specific details are set forth in order to provide a thorough understanding of embodiments of the present invention. However, those skilled in the art will understand that such embodiments may be practiced without these specific details. Furthermore, just as every particular reference may embody particular methods, systems, yet not require such, ultimately such teaching is meant for all expressions notwithstanding the use of particular embodiments. Reference throughout this specification to “one embodiment” or “an embodiment” means that a particular feature, structure, or characteristic described in connection with the embodiment is included in at least one embodiment of the present invention.

The present invention defines a system and method for a three-dimensional puzzle set, wherein puzzle pieces in the set comprise main body with top, side and bottom surfaces, and mechanical interlocking elements comprising projections and recesses. The puzzle pieces optionally comprise electrical circuits and components which interact with each other when assembled.

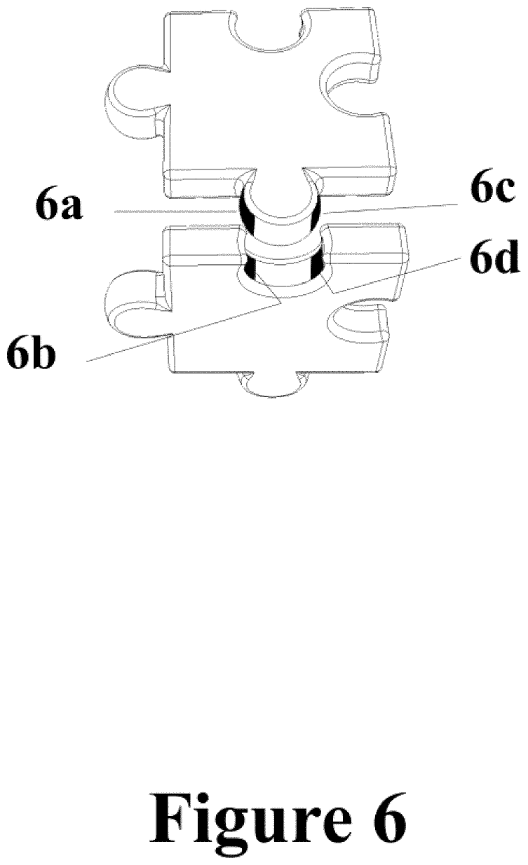

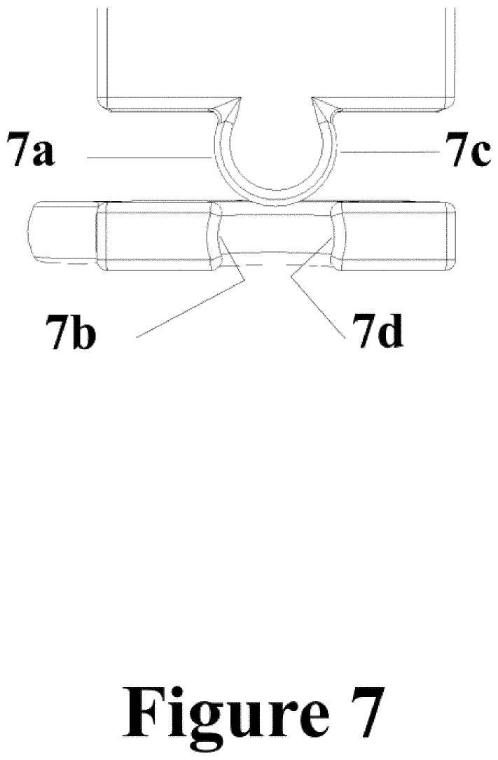

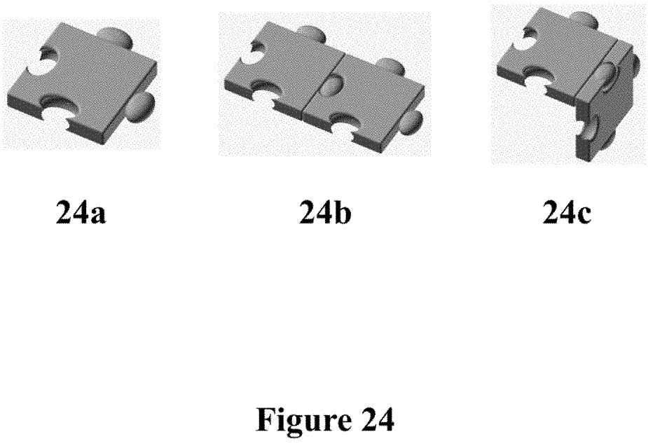

Projection and recess are the heart of present invention for implementing a mechanical interlock of the puzzle game pieces. The projections and recesses are ellipsoid in general as depicted in FIG. 24 in 24a, and spherical in particular as depicted in FIGS. 6 and 7, thus enabling rotation of interlocked puzzle pieces around each other. In on embodiment of the present invention the projections and recesses are positioned on the side surface of the puzzle pieces. For non-spherical projections and recesses, the projection can only be pitch-rotated within the recess, while for spherical projections and recesses the projection can be rotated within the recess around multiple axes, specifically pitch-rotated and roll-rotated.

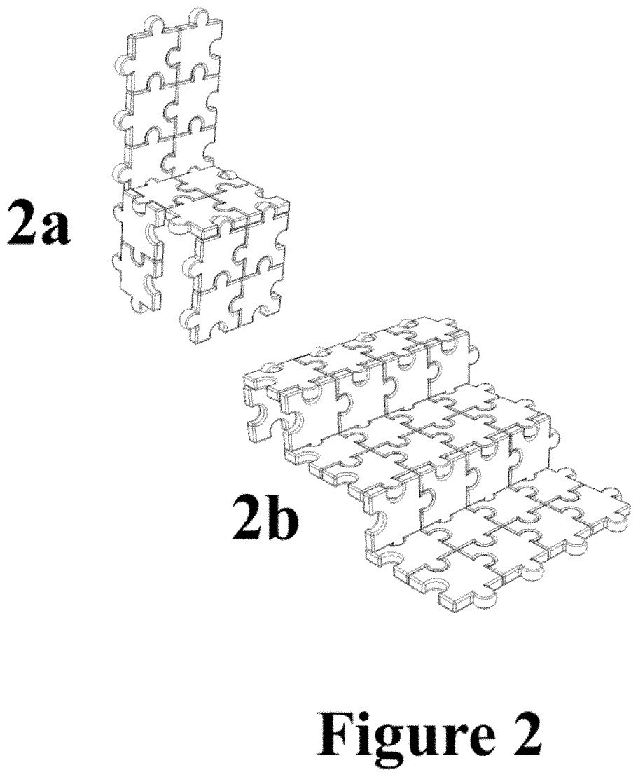

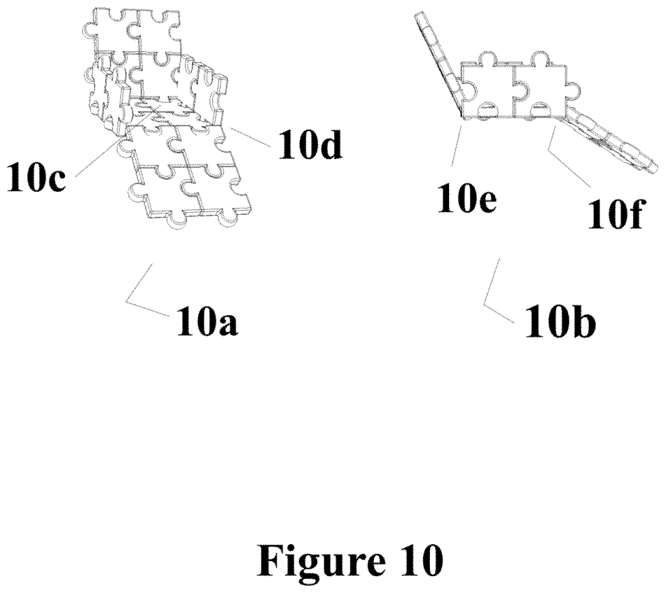

FIG. 2 depicts two examples of three-dimensional puzzle assemblies—a chair 2a and stairs 2b. These assemblies are made of both parallel and perpendicular mating of puzzle pieces. The TV chair depicted in FIG. 10 further demonstrates attaching of puzzle pieces according to the present invention in various angles, not limited to straight angle (180 degrees) or right-angle (90 degrees).

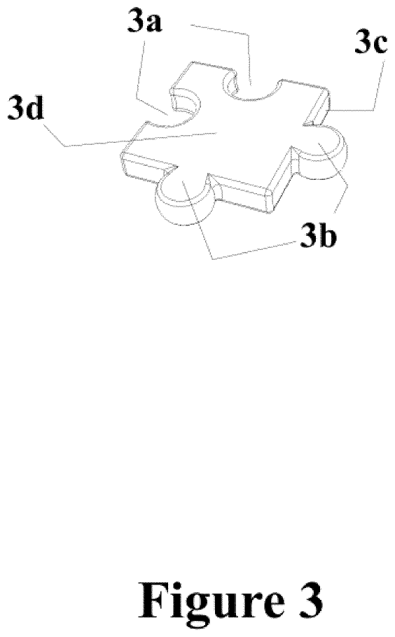

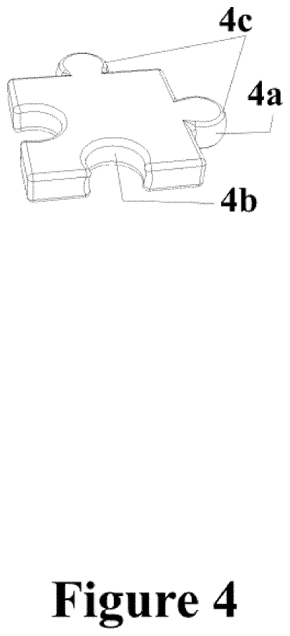

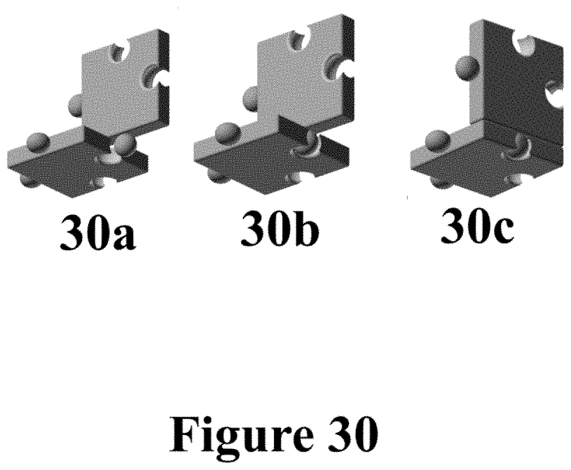

In one embodiment of the present invention the ellipsoid projections are truncated on their top and bottom in order to be coplanar with the puzzle piece's main body top surface and bottom surface respectively as depicted in FIG. 3 in 3b. In this embodiment said ellipsoid recesses are open in the top, side and bottom surfaces as depicted in FIG. 4, enabling the insertion of the projection by pushing it as depicted on FIGS. 6 and 7. Such ability is easily achieved by using flexible materials for building the puzzle pieces. Moreover, said projection can be inserted into said recess by first rotating it 90 degrees, then inserting it to the recess and finally rotate it back 90 degrees. FIG. 30 depicts this technique wherein 30a shows the top puzzle piece rotated 90 degrees before inserted to the bottom puzzle piece, 30b shows both puzzle pieces after the insertion and 30c shows both puzzle pieces after rotating back the top puzzle piece.

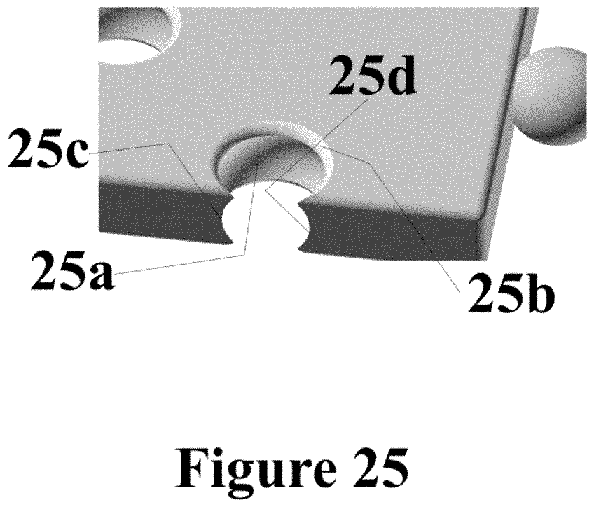

FIG. 6 depicts a spherical projection of one puzzle piece is inserted into a spherical recess of another puzzle piece, and the friction formed due to the significant surface touching area is enough to hold the puzzle piece from falling. Exemplary touching surface areas are depicted in 6a and 6b, filled with black color, which form a friction on the left side of the assembly. Similarly, the touching surface areas depicted in 6c and 6d, filled with black color, form a friction on the right side of the assembly. At the heart of this principle is a spherical interlock, which is formed when a projection is inserted into a recess, as closely depicted in FIG. 7: in this embodiment of the present invention, the spherical shape of the recess accommodating section matches the spherical shape of the projection, thus causing an interlock after insertion. FIG. 25 depicts a close look of a recess with spherical shape: 25a is a view of the spherical curvature, 25b shows said recess opening in the top surface, and 25a and 25d show said recess opening in the side surface.

It will be appreciated to those skilled in the art that using flexible materials in producing the puzzle pieces is one of several methods to facilitate said projection to be snapped into said recess.

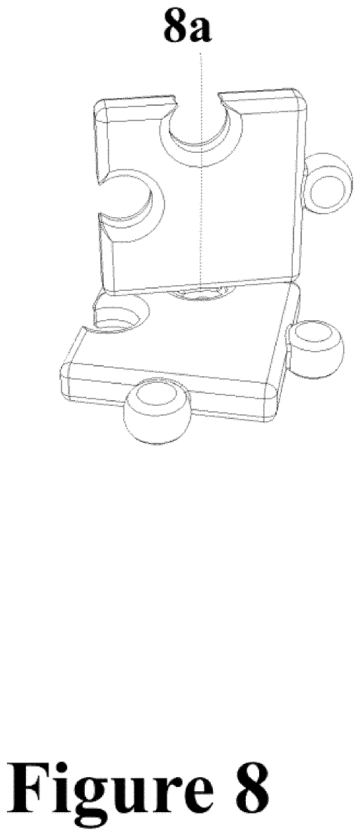

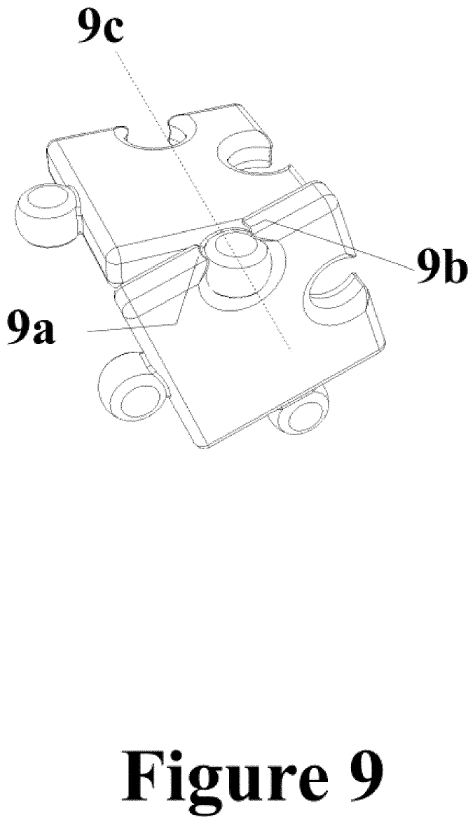

FIGS. 8 and 9 further demonstrate roll-rotation of two perpendicularly mated puzzle pieces: the top puzzle piece may be rotated around the axis perpendicular to the bottom puzzle piece top surface, as depicted in 8a and 9c. In this embodiment of the present invention the angle of the projection rotation is limited only by the opening of the recess on the side surface, as depicted in 9a and 9b. It will be appreciated to those skilled in the art that the recess opening width can be controlled by moving the recess' center inward for narrower opening and outward for wider opening, along with making a matching opposite change to the projection—move its center outward for a narrower opening and inward for a wider opening.

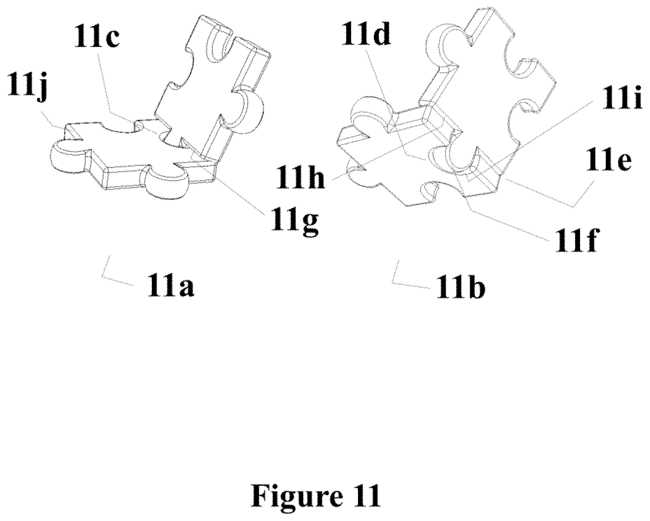

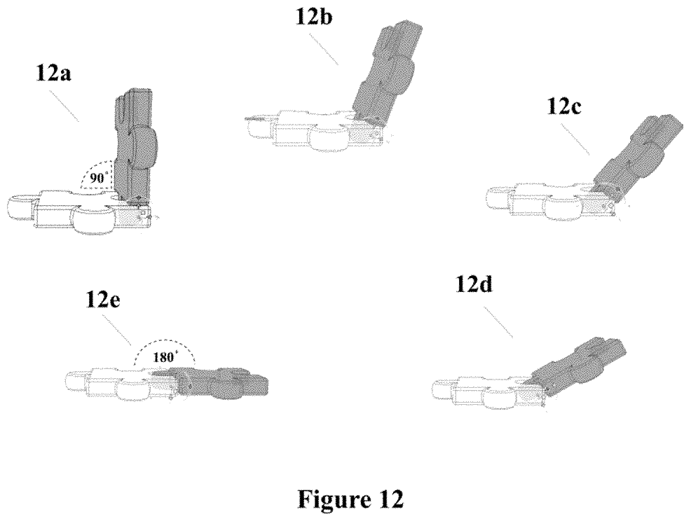

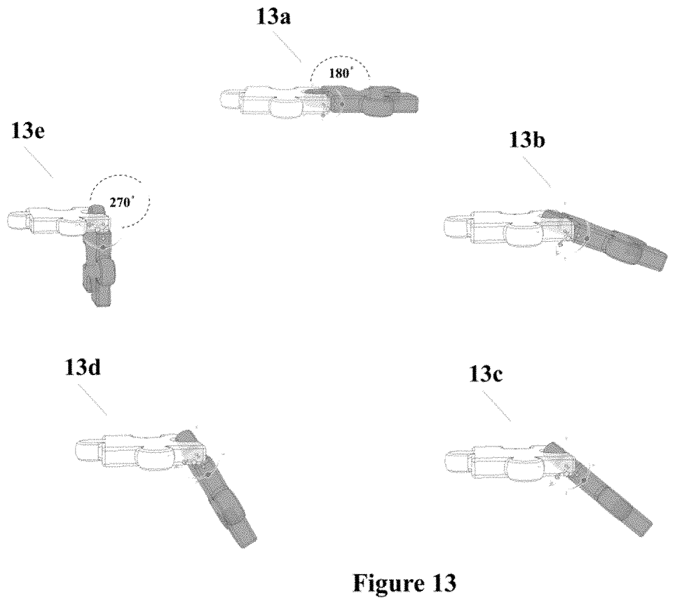

According to the present invention puzzle pieces can be pitch-rotated in various angles as depicted in FIGS. 10, 12 and 13. FIG. 11 shows closely how the projection-recess interlock is used to achieve assembly angles other than 90 degrees and 180 degrees. FIG. 12 depicts a gradual pitch-rotating of one puzzle piece around another, starting at right-angle (12a) and ending at straight angle (12e). FIG. 13 further depicts a gradual pitch-rotating of one puzzle piece around another starting at straight angle (13a) and ending at 270 degrees angle (13e).

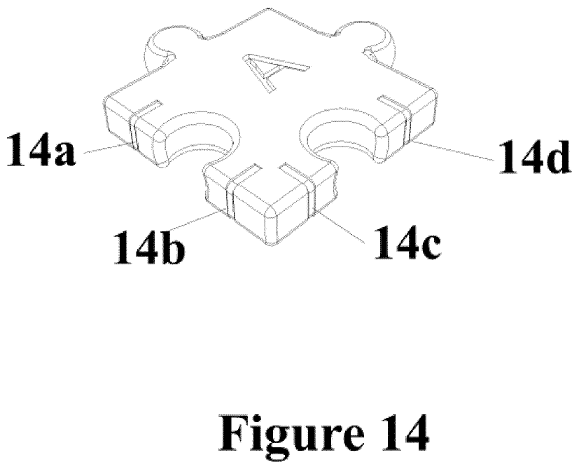

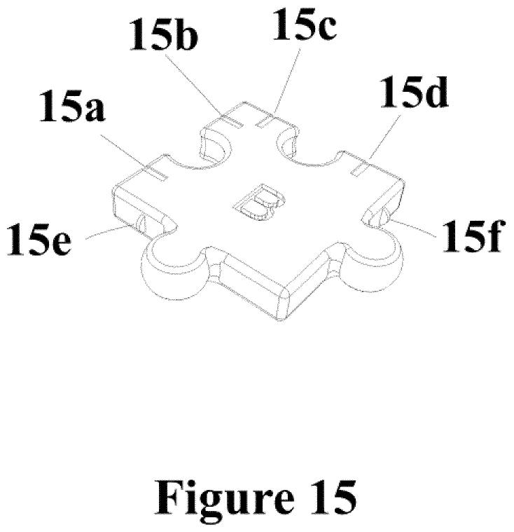

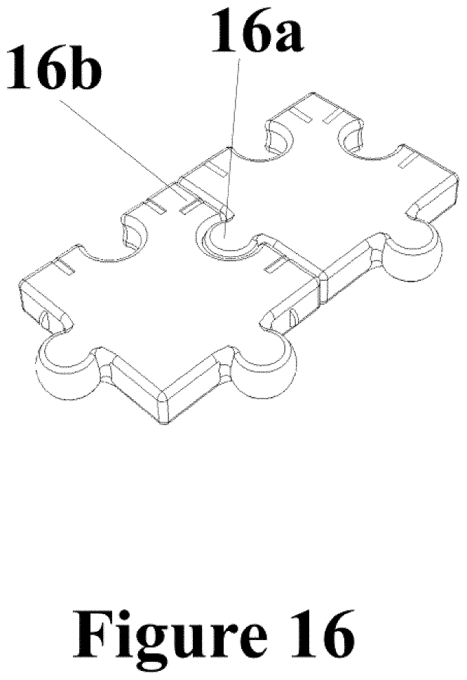

According to the present invention electrical circuits can be formed by assembling puzzle pieces. As depicted in FIGS. 14 and 15, in one embodiment of the present invention electric conductive contacts are placed on surfaces of said puzzle piece to allow multi directional assembly of puzzle pieces. Male spring contacts depicted in 15e and 15f are placed on the side surface, and when said puzzle piece is mated with a second puzzle piece said spring contacts are pressed onto said second puzzle piece's matching female contacts. FIG. 16 depicts such a parallel assembly of two puzzle pieces, where the spring contact is attached to the female contact on the side surface, as depicted in 16b. The projection-recess interlock depicted in 16a presses the two puzzle pieces towards each other, thus pressing the spring contact towards the matching female contact. In one embodiment of the present invention the female contacts depicted in FIGS. 14 and 15 are sunk a little inside a slot, in order to guide the spring contact inside and to ensure a proper electrical conduction.

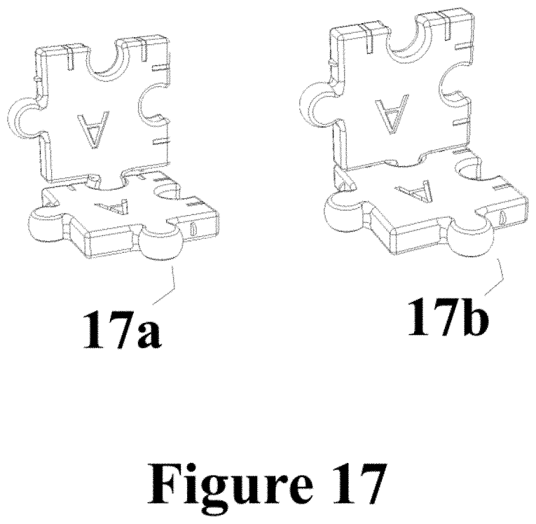

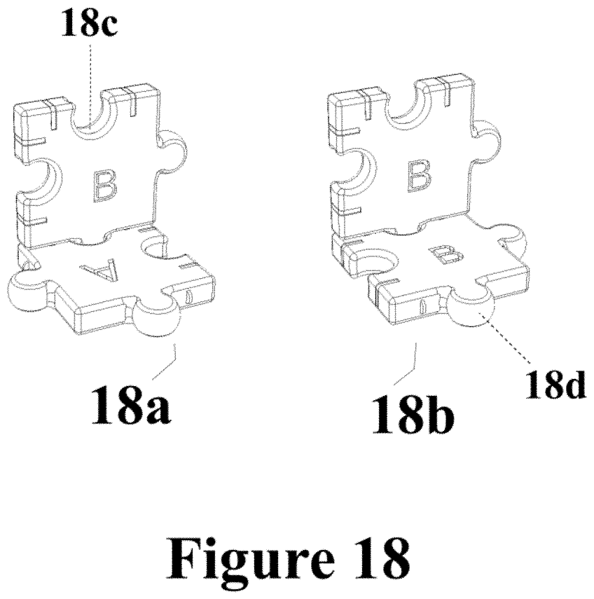

FIG. 17 depicts a right-angle assembly of two puzzle pieces, demonstrating one embodiment of the present invention where the projection-recess interlock presses a top puzzle piece towards a bottom puzzle piece, thus pressing the spring contact of said top puzzle piece vertically towards the female contact of said bottom puzzle piece. 17a depicts the right-angle assembly just before fully inserting top puzzle piece's projection into bottom puzzle piece's recess, where in 17b the projection is already snapped into the recess. FIG. 18 further demonstrates other options for vertical assemblies of puzzle pieces: 18a shows an assembly similar to that in FIG. 17 but with said top puzzle piece roll-rotated 180 degrees around its vertical axis depicted in 18c. 18b is an assembly similar to that in FIG. 17 but with said bottom puzzle piece pitch-rotated 180 degrees.

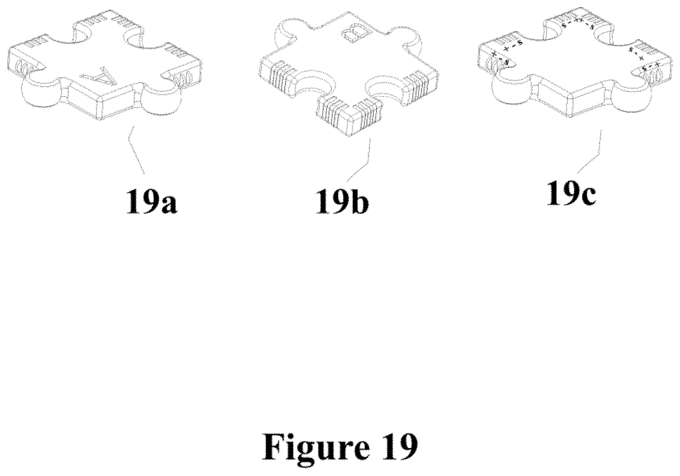

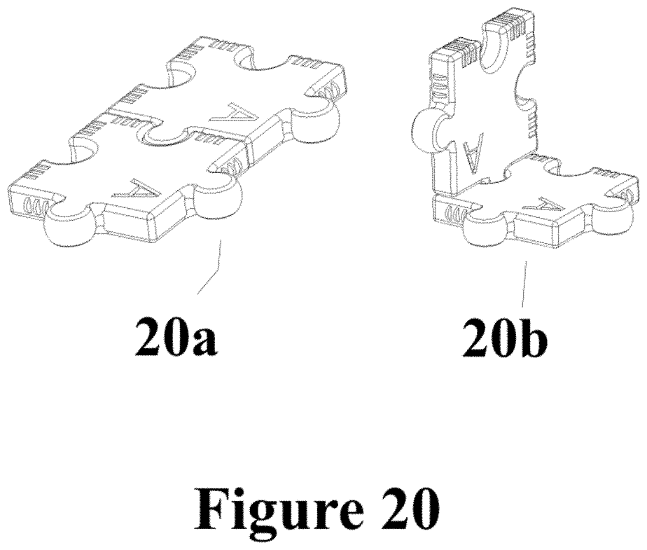

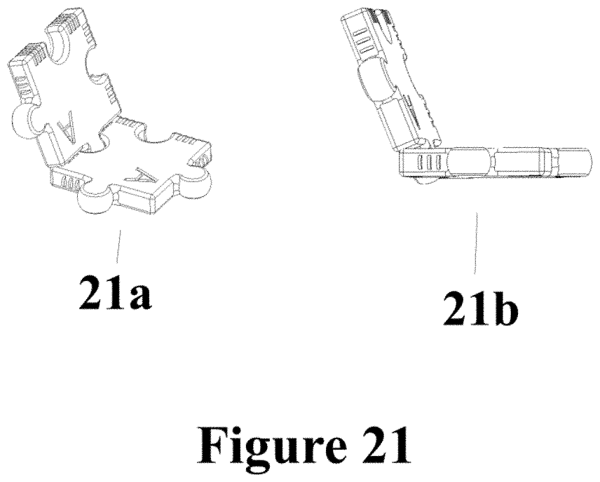

In preferred embodiments of the present invention the male and female contacts are each a three-position contact, as depicted in FIG. 19. 19a depicts a puzzle piece with two three-position male spring contacts on its side surfaces, while four three-position contacts depicted in both FIGS. 19a and 19b are the matching female contacts to said spring contacts. The female contacts have a U-shape, ranging from side A, along the side surface to side B, thus enabling assembly and electrical contact of mated puzzle pieces in any direction. FIG. 20 depicts two non-limiting examples of such assemblies—parallel (20a) and perpendicular (20b). FIG. 21 depicts another non-limiting example of an obtuse angle assembly of two puzzle pieces, where the spring male contact is attaching the female contact in any angle, due to its protrusion and flexibility. The three-position contact is preferred over one-position and two-position contacts as many electrical components require power/plus (+), ground/minus (−) and signal(s) inputs, as depicted in 19c, letting puzzle pieces contain various types of electrical components.

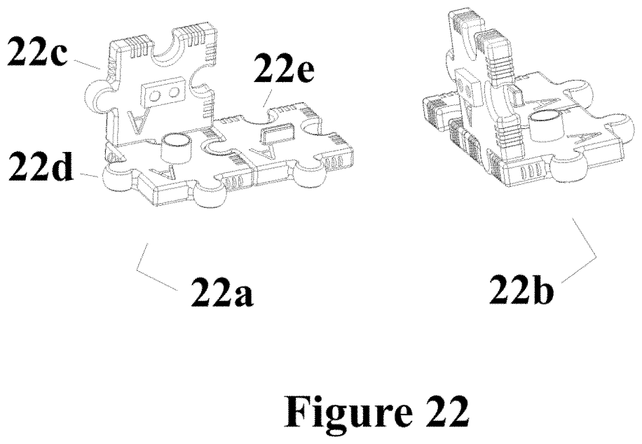

In one embodiment of the present invention, FIG. 22 depicts an assembly of three puzzle pieces each comprising electrical three-position male and female contacts and extra electrical components: a proximity sensor puzzle piece (22c), a speaker puzzle piece (22d) and a USB connector puzzle piece (22e). In this embodiment when the proximity sensor senses an object it outputs a corresponding value on the signal contact, which is transferred to the speaker puzzle piece signal input, which causes the speaker to make a sound. The power to the whole assembly is coming in this embodiment from the USB puzzle piece, when connected with a suitable cable to a wall adapter or to a computer USB output. In 22b the proximity sensor puzzle piece is rotated 180 degrees around its vertical axis so that now it “looks” to the opposite direction with regards to its previous direction depicted in 22a. As can be seen from the markings on 19c, on each of the directions of the proximity sensor puzzle piece the touching contacts are in order: the spring male power/plus (+) touches the female contact power/plus (+), the spring male contact ground/minus (−) touches the female contact ground/minus (−), and the spring male contact signal(s) touches the female contact signal(s). As can be seen in this embodiment of the present invention, in any mating direction of two puzzle pieces the three-position spring male contacts touch the three-position female contacts in order.

The non-limiting example depicted in FIG. 22 demonstrates a basic puzzle circuit containing one sensor, one actuator and one power source. In alternative embodiments, a puzzle piece assembly may contain a plurality of sensor puzzle pieces of various types, a plurality of actuator puzzle pieces of various types and power source puzzle pieces of various types. Non-limiting examples of other sensor types are temperature sensor, pressure sensor, light sensor, microphone, touch sensor, push button, switch button, slider switch, etc. Non-limiting examples of other actuator types are LED, electric DC motor, servo motor, IR transmitter, RGB LED, and LCD screen.

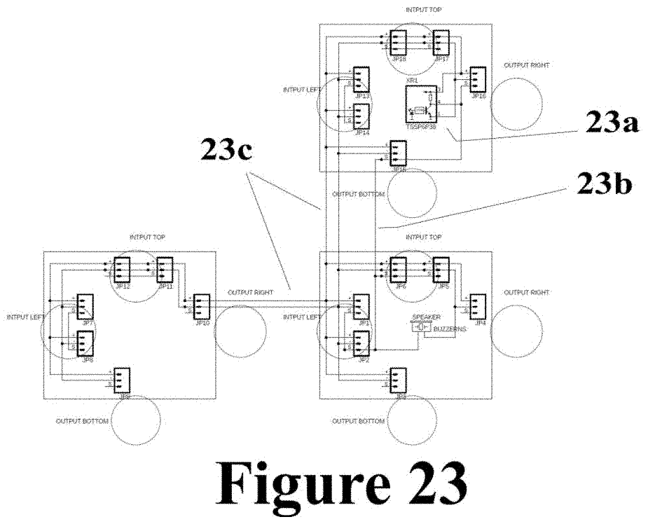

The electrical circuit of the puzzle assembly depicted in FIG. 22 is depicted in FIG. 23 and is a non-limiting example of an electrical implementation. In this embodiment, each of the three puzzle pieces is represented by a rectangle containing its internal circuit, while routes between said rectangles represent inter-pieces connections. Specifically, in this embodiment all power/plus (+) contacts are connected to each other; all ground/minus (−) contacts are connected to each other; input left signal is connected to input top signal; output right signal is connected to output bottom signal. This wiring in this non-limiting example of the present invention enables input coming from any direction to be well received by the puzzle piece logic. Likewise, making same output to both bottom and right output signals enables connecting the next puzzle piece to any of the two. In the electrical diagram, the proximity sensor located within the proximity sensor puzzle piece (23a), senses objects and passes the sensed voltage value to both its output right signal and output bottom signal (through its pin number 4). The signal is then passed from the proximity puzzle piece's bottom spring male contact to the speaker puzzle piece female contact (23b), and then directly to the buzzer pin, causing it to make sounds when the sensed value is high. The power/plus (+) and minus (+) originating from the USB puzzle piece are common to all three puzzle pieces and are connected by spring male contacts and female contacts as depicted in 23c.

In one embodiment of the present invention some of said puzzle pieces comprise logic gates which can be positioned in a chain of assembled puzzle pieces to activate a logic operation on the electric signal passing through. Non limiting example of such logic gates are OR, AND, NOT and XOR. In one embodiment of the puzzle set the recesses and projections of a puzzle piece comprising logic a gate denote the logic gate inputs and logic gate outputs respectively, thus puzzle pieces mated with said puzzle piece's recesses will be considered input puzzle pieces and puzzle pieces mated with said puzzle piece's projections will be considered output puzzle pieces.

In one embodiment of the present invention a power source provides electric power to the rest of the puzzle pieces' electric circuits and electric components. Non-limiting examples of power source types are batteries, either external to the puzzle set or included in one or more of the puzzle pieces, USB cable connected to a computer USB port or a power cable connected to a wall adapter.

In an alternative embodiment of the present invention a micro-processor puzzle piece may be part of a puzzle set, optionally reading from sensor puzzle pieces, running logic and making outputs to other puzzle pieces assembled in the set.

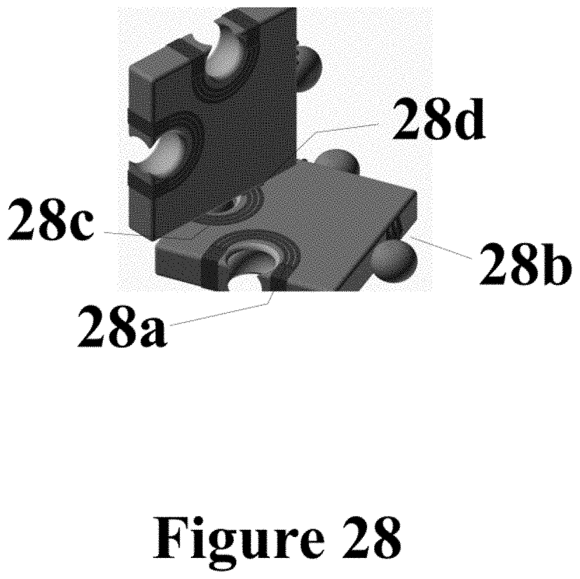

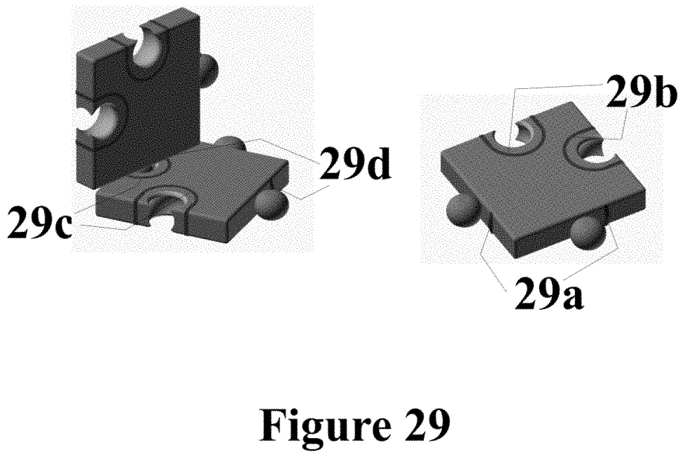

In an alternative embodiment of the present invention the puzzle pieces top and bottom surfaces comprise arc-shape conductive contacts to facilitate electric conductive contact between mated puzzle pieces while roll-rotating. FIG. 29 depicts puzzle pieces with such 29b arc-shape one-position conductive contacts facilitating electric conductive contact while roll-rotating. FIG. 28 further depicts two mated puzzle pieces with three-position spring contacts (28b and 28d) and with matching three-position arc-shape conductive contacts (28a and 28c) facilitating electric conductive contact while roll-rotating.

It will be appreciated to those skilled in the art how to construct electrical circuits for various electrical components such as actuators, sensors, micro-processors, logic gates, etc. The simple circuits shown above are no-limiting examples of the present invention.

Although selected embodiments of the present invention have been shown and described, it is to be understood the present invention is not limited to the described embodiments. Instead, it is to be appreciated that changes may be made to these embodiments without departing from the principles and spirit of the invention, the scope of which is defined by the claims and the equivalents thereof.

What is claimed is:

1. A puzzle set comprising:
a plurality of puzzle pieces each comprising top surface, bottom surface and side surface, wherein said side surface comprising plurality of ellipsoid projections and ellipsoid recesses, and wherein said ellipsoid projections match said ellipsoid recesses;
and wherein when mating one of said ellipsoid projections of one of said puzzle pieces with one of said ellipsoid recesses of another of said puzzle pieces, mated puzzle pieces are mechanically interlocked and can be rotated with relation to their mating point.

2. The puzzle set according to claim 1 wherein said ellipsoid projections are spherical projections and said ellipsoid recesses are spherical recesses.

3. The puzzle set according to claim 1 wherein said top surface and said bottom surface are planar.

4. The puzzle set according to claim 1 wherein said puzzle set is a jigsaw puzzle set.

5. The puzzle set according to claim 1, wherein said mating of said puzzle pieces at any mating angle is retained due to a friction between said ellipsoid projections and said ellipsoid recesses.

6. The puzzle set according to claim 1, wherein said puzzle pieces are interchangeable, and wherein said puzzle pieces are mechanically attachable to one another by attaching said ellipsoid projections and said ellipsoid recesses.

7. The puzzle set according to claim 1, wherein said ellipsoid recesses are open in the said top surface, said side surface and said bottom surface to facilitate insertions of said ellipsoid projections into said ellipsoid recesses.

8. The puzzle set according to claim 1 wherein edges of said top surface and said bottom surface are rounded so that it is easier for any two of said puzzle pieces to be mated and pitch-rotated around each other.

9. The puzzle set according to claim 1 wherein said puzzle pieces comprising each two or more conductive contacts over said top surface, said side surface and said bottom surface, wherein mating two of said puzzle pieces yields conduction between their said conductive contacts.

10. The puzzle set according to claim 9 wherein said conductive contacts are U-shape and are positioned at edges of said puzzle pieces, so that said conductive contacts lie on said top surface, said side surface and said bottom surface of said puzzle pieces.

11. The puzzle set according to claim 9 wherein said top surface and said bottom surface comprising arc-shape conductive contacts with radiuses matching positions of said conductive contacts of said puzzle pieces so that conduction is retained during roll-rotating of said puzzle pieces.

12. The puzzle set according to claim 9 wherein said conductive contacts comprise spherical projection male connectors and conduit female connectors positioned on said ellipsoid projections and said ellipsoid recesses of said puzzle pieces respectively, so that a conduction is retained while pitch-rotating of said puzzle pieces and while roll-rotating of said puzzle pieces.

13. The puzzle set according to claim 9 wherein said conductive contacts comprise spherical projection male connectors and conduit female connectors positioned on said recesses and said projections of said puzzle pieces respectively, so that a conduction is retained while pitch-rotating of said puzzle pieces and while roll-rotating said puzzle pieces.

14. The puzzle set according to claim 9 wherein some of said conductive contacts of said puzzle pieces are spring contacts.

15. The puzzle set according to claim 9 wherein on or more of said puzzle pieces comprising an electric circuit wherein said conductive contacts are part of said electric circuit.

16. The puzzle set according to claim 15 wherein one or more of said puzzle pieces comprising a power source.

17. The puzzle set according to claim 15 wherein one or more of said puzzle pieces comprising sensors, and one or more of said puzzle pieces comprising actuators, wherein in assemblies of said puzzle pieces, said electric circuits of assembled said puzzle pieces are electrically connected through said conductive contacts.

18. The puzzle set according to claim 17 wherein one or more of said puzzle pieces comprising a microprocessor.

19. The puzzle set according to claim 17 wherein in said mating one of said puzzle pieces comprising one of said sensors with one of said puzzle pieces comprising one of said actuators, output voltage of one of said sensors becomes an input voltage for one of said actuators.

20. The puzzle set according to claim 17 wherein one or more of said puzzle pieces comprising logic gates.
